(19) United States
(12) Patent Application Publication
(10) Pub. No.: US 2012/0255073 A1
(43) Pub. Date: Oct. 4, 2012

(54) SCANNING PROBE LITHOGRAPHY APPARATUS AND METHOD, AND MATERIAL ACCORDINGLY OBTAINED

(76) Inventors: Michel Despont, Wadenswil (CH); Urs T. Duerig, Rueschlikon (CH); Bernd W. Gotsmann, Horgen (CH); Armin W. Knoll, Adliswil (CH); David Santos Pires, Allschwil (CH); Peter Vettiger, Langnau (CH)

(21) Appl. No.: 13/501,487

(22) PCT Filed: Oct. 13, 2010
(86) PCT No.: PCT/IB10/54630

§ 371 Date: May 25, 2012

(30) Foreign Application Priority Data
Oct. 13, 2009 (EP) 09172880.8

(51) Int. Cl. G01Q 80/00; G01Q 70/10

(52) U.S. Cl. 850/57; 850/62

(57) ABSTRACT

A scanning probe lithography (SPL) apparatus, an SPL method, and a material having a surface thickness patterned according to the SPL method. The apparatus includes: two or more probes with respective shapes, where the respective shapes are different and the respective shapes form, in operation, different patterns in a thickness of a surface of a material processed with the apparatus.

### FIELD OF THE INVENTION

The invention relates to the field of probe-based methods for patterning a surface of a material. In particular, it relates to scanning probe lithography (herein after SPL). It may furthermore be directed to high resolution/high throughput patterning, such as nano-scale patterns with feature sizes of e.g. less than 22 nanometers (nm).

### BACKGROUND OF THE INVENTION

Lithography is a process for producing patterns of two dimensional shapes, consisting of drawing primitives such as lines and pixels within a layer of material, such as, for example, a resist coated on a semiconductor device.

A conventional lithography is the photolithography or optical lithography. Many alternative approaches are known, for example in the field of nano lithography, which can be seen as high resolution patterning of surfaces. Nanolithography refers to fabrication techniques of nanometer-scale structures, comprising patterns having one dimension typically sizing up to about 100 nm (partly overlapping with photolithography). Beyond the conventional photolithography, they further include such techniques as charged-particle lithography (ion- or electron-beams), nanoimprint lithography, its variants, and SPL (for patterning at the nanometer-scale). SPL is for instance described in detail in Chemical Reviews, 1997, Volume 97 pages 1195 to 1230, “Nanometer-scale Surface Modification Using the Scanning Probe microscope: Progress since 1991”, Nyffenegger et al. and the references cited therein.

In general, SPL is used to describe lithographic methods wherein a probe tip is moved across a surface to form a pattern. SPL makes use of scanning probe microscopy (SPM) techniques. SPM techniques rely on scanning a probe, e.g. a sharp tip, in close proximity with a sample surface whilst controlling interactions between the probe and the surface. A confirming image of the sample surface can afterwards be obtained, typically using the same scanning probe in a raster scan of the sample. In the raster scan, the probe-surface interaction is recorded as a function of position and images are produced as a two-dimensional grid of data points.

The lateral resolution achieved with SPM varies with the underlying technique: atomic resolution can be achieved in some cases. Use can be made of piezoelectric actuators to execute scanning motions with a precision and accuracy, at any desired length scale up to better than the atomic scale. The two main types of SPM are the scanning tunneling microscopy (STM) and the atomic force microscopy (AFM). Acronyms STM/AFM may in fact refer to either the microscopy technique or to the microscope itself.

In particular, the AFM is a device in which the topography of a sample is modified or sensed by a probe mounted on the end of a cantilever. As the sample is scanned, interactions between the probe and the sample surface cause pivotal deflection of the cantilever. The topography of the sample may thus be determined by detecting this deflection of the probe. Yet, by controlling the deflection of the cantilever or the physical properties of the probe, the surface topography may be modified to produce a pattern on the sample.

Following this idea, in a SPL device, a probe is raster scanned across a functional surface and brought to locally interact with the functional material. By this interaction, material on the surface is removed or changed. In this respect, one may distinguish amongst:
constructive probe lithography, where patterning is carried out by transferring chemical species to the surface; and
destructive probe lithography, which consists of physically and/or chemically deforming a substrate's surface by providing energy (mechanical, thermal, photonic, ionic, electronic, X-ray, etc.).

SPL is accordingly a suitable technique for nano lithography.

High resolution patterning of surfaces is relevant to several areas of technology, such as alternatives to optical lithography, patterning for rapid prototyping, direct functionalization of surfaces, mask production for optical and imprint lithography, and data storage.

In particular, lithography can be used for the fabrication of microelectronic devices. In this case, next to conventional lithography, electron-beam (or e-beam) and probe-based lithography are mostly in use.

For high resolution optical mask and nano-imprint master fabrication, e-beam lithography is nowadays a standard technology. However, when approaching high resolutions, writing times for e-beam mask/master fabrication increase unfavorably.

As a possible alternative, the use of probes for such patterning is still under development. At high resolution (<32 nm), the speed of single e-beam and single probe structuring converges.

Besides, the so-called ML2 maskless Lithography has attracted significant interest because it can reduce the cost and lead time associated with mask fabrication in process development and IC prototyping. ML2 refers to the use of the parallel operation of several e-beams. In fact, ML2 has been perceived as a promising technology in the last decades because of its superior resolution and flexibility. However, the low throughput of ML2 (compared to that of e.g. optical lithography) has excluded it from high volume manufacturing. This technology has thus been merely used for niche applications. Its main drawback arises due to the low exposure throughput of single charged particle beams. To remedy this, electron-beam lithography systems operating a large number of beams in parallel to reduce the overall exposure time are currently under development. Another way of increasing throughput, using e-beam, is the so-called character projection technique. Here, the parallelism is added by having a broad beam shaped by a shadow mask to a specific structure. The shadow mask allows to model a “character”, serving as a main building block which will form, after the subsequent exposure of different characters at different positions, the desired lithography pattern. Although this has led to a major improvement in throughput, such a system does however not have a throughput that is competitive enough for applications in chip manufacturing. In addition, for research and development, it suffers a lack of resolution and a high cost due to the required e-beam. In addition, the stitching accuracy and the proximity effect between the exposures of two adjacent characters remains an issue.

SPL based systems have interesting attributes such as their compactness and simplicity, whereby the manufacturing of large arrays of probes for massive parallel operation is possible. However, even with massive parallelism, throughput is still a major issue for applications such as chip manufacturing.

### BRIEF SUMMARY OF THE INVENTION

According to one aspect thereof, the present invention provides a scanning probe lithography or SPL apparatus, comprising two or more probes with respective shapes, the respective shapes differing such as to form, in operation, different patterns in a thickness of a surface of a material processed with the apparatus.

In embodiments, the SPL apparatus may comprise one or more of the following features:
the SPL apparatus further comprises means for independently actuating the probes;
the SPL apparatus further comprises an electronic circuitry designed to command independent actuation of the probes;
the probes comprise respective cantilevers, the cantilevers terminated by respective tips, the tips having at least two different shapes;
the SPL apparatus further comprises one or more array of cantilevers, with substantially a same maximal character size allocated to each of the cantilevers;
the respective shapes have dimensions such as to form nano-scale patterns in the surface thickness; and
one or more of the probe shapes is designed such as to form 3D hole pattern in the surface thickness.

The invention is further directed, according to another aspect, to a SPL method, comprising the steps of: providing an SPL apparatus according to the invention; and forming patterns in a thickness of a surface of a material.

In further embodiments, the method may comprise one or more of the following features:
the step of forming comprises moving the probes across the surface and independently actuating the probes to make them locally interact with the surface such as to form respective patterns;
the step of forming further comprises moving the probes such that a first pattern obtained with a first one of the probes overlaps with a second pattern obtained with a second one of the probes;
the method further comprises the steps of, if necessary, descumming the surface, transferring the nano-scale patterns in a layer of the material contiguous to the patterned thickness and removing the residual thickness;
the step of forming further comprises independently varying: the forces applied to the probes, the temperatures of the said probes and/or exposure times of the probes on the material surface; and
the step of providing further comprises providing a material having a polymer film with a network of molecules cross-linked via intermolecular, non essentially covalent bonds; and the step of forming patterns further comprises patterning the film with the probes, part or all of the probes heated such as to desorb molecules from the network.

According to yet another aspect, the present invention is directed to a material having a surface thickness patterned according to the method of the invention, and preferably, substantially free of proximity effects.

An apparatus, a method and a material embodying the present invention will now be described, by way of non-limiting example, and in reference to the accompanying drawings.

### BRIEF DESCRIPTION OF SEVERAL VIEWS OF THE DRAWINGS

FIG. 1 is a picture (free color scale) representing an example of integration of two cantilevers of an SPL apparatus, with two different tip shapes, according to an embodiment of the invention.

FIGS. 2.A-C schematically depict three cantilevers of another embodiment, with three different tip shapes;

FIG. 3 schematically depicts an example of a cantilever used in yet another embodiment, designed such as to form a 3D hole pattern in the surface thickness of a material;

FIG. 4 illustrates a schematic SPL apparatus according to an embodiment of the invention;

FIGS. 5-12 schematically depict steps of an embodiment of the method according to the invention.

### DETAILED DESCRIPTION OF THE INVENTION

As an introduction to the following description, it is first pointed at general aspects of the invention, notably directed to a scanning probe lithography (or SPL) apparatus. The apparatus comprises physical probes with different shapes. The shapes actually differ such as to be able to form different patterns in the surface thickness of a material. Therefore, the diversity of patterns obtained during a raster scan of the material surface is increased. Typically, the idea is to use tips of specific shapes to imprint their shapes (or characters) in a polymer, whereby a complex structure can be created in one imprint step. Throughput of SPL is accordingly improved. Most advantageously, the probes are independently actuated, in order to further increase the diversity of patterns. Character probe lithography is thereby instated.

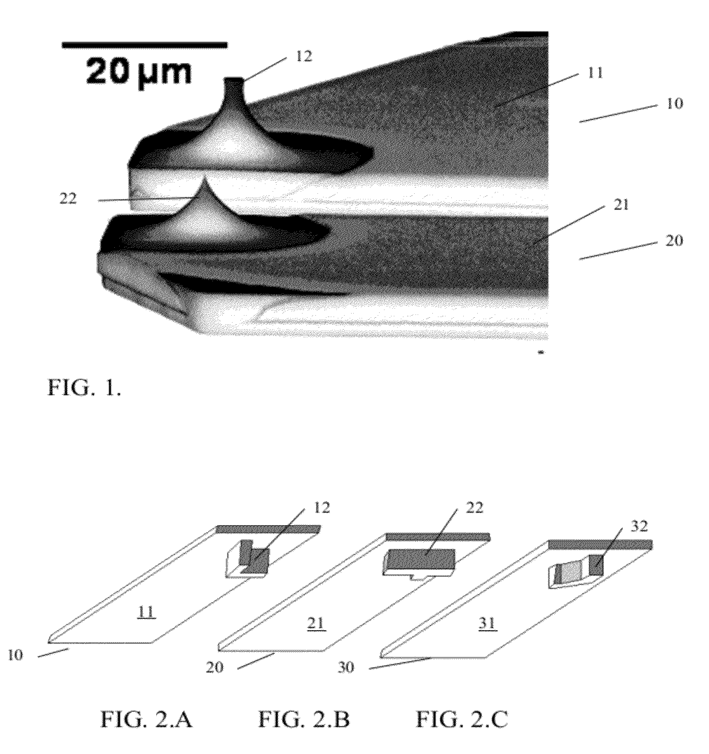

To prove the feasibility of the concept, FIG. 1 shows a picture representing an example of integration of two probes 10, 20, i.e. two cantilevers 11, 21 of an SPL apparatus (not shown) according to an embodiment. As illustrated, the cantilevers are terminated by tips 12, 22 with two different tip shapes. One is very sharp; the other extends up to a flat section. Such an arrangement provides two letters and thus a (short) alphabet. Obviously, other shapes can be contemplated, as illustrated in the following. Note that in FIG. 1, grayscale and contrast have been freely tuned.

FIGS. 2.A-C schematically depict three probes 10, 20, 30, each comprising a cantilever 11, 21, 31 and a specific tip 12, 22, 32. As can be seen, the shapes of tips 12, 22, 32 here respectively show an “L”, “T”, “J” transverse section (approximately), providing now an alphabet consisting of three letters. More generally, the probes composing the SPL apparatus probes have respective shapes which suitably differ, such as to form sufficiently different patterns in the thickness of the sample surface to be processed. As said above, this allows larger SPL throughput.

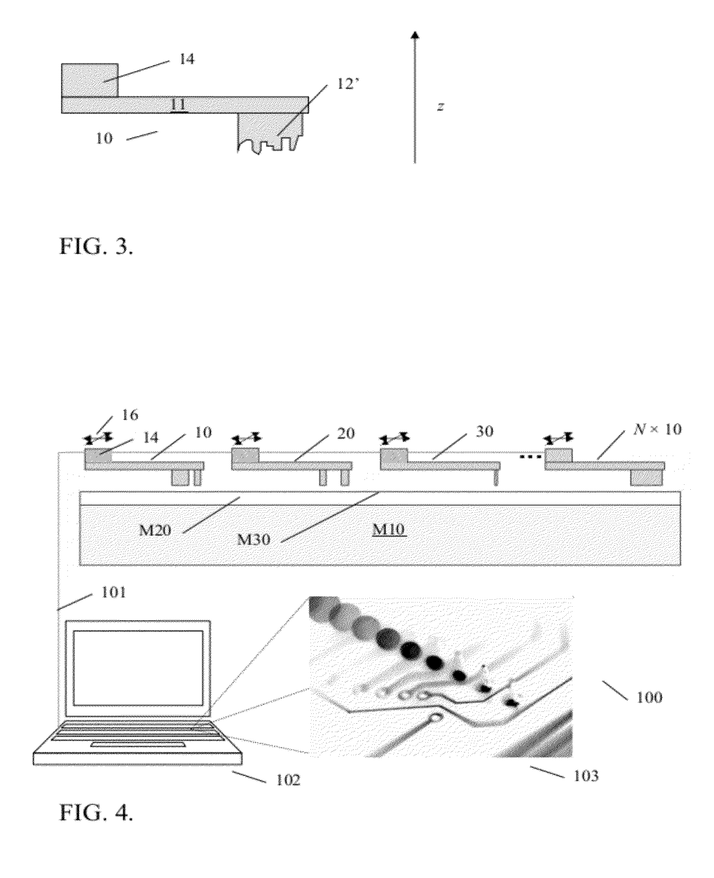

FIG. 3 schematically depicts another example of probe 10, designed for 3D imprint of the sample surface. Here, the probe 10 comprises a (usual) cantilever 11 and a distal tip 12 whose section has an arbitrary profile along z, at variance with the exemplary probes of FIG. 2. This way, 3D patterns can be obtained when the probe tip is brought locally in contact with a sample surface. Obviously, various 3D shapes can be contemplated too, thereby increasing the complexity of the patterns and the information density.

As a variant, note that 3D patterns can else be obtained by varying the force applied to the probes, from one elementary patterning step to another. Preferably, this can be carried out independently for each of the probes. Possible alternatives consist of varying the temperatures or exposure times of the probes on the material surface.

To achieve this, the probes are preferably actuated independently from one another.

For example, a cantilever can be actuated by means of piezoelectric actuators. FIG. 3 schematically represents such an actuator 14. Preferably yet, piezoelectric actuators are integrated therein, as well as piezoresistor sensors, if necessary. The cantilever 11 is typically made of silicon. It is for instance provided with a sensing part having a coat of boron serving as piezoresistor, and a sensing signal transmitting part for transmitting the electric signal to the piezoresistor. Preferably, no use is made of piezoresistive sensing. Rather, thermomechanical effect can be used for writing and sensing.

FIG. 4 illustrates more completely an SPL apparatus. In this embodiment, the SPL apparatus is shown to have an electronic circuitry 101, 103 designed to independently actuate the probes 10, 20, . . . and in fine, the tips 12, 22, . . . . In operation, independent actuation of the probes allows for obtaining a larger diversity of patterns. In practice, the electronic circuitry is typically part of a computer 102, suitably programmed for obtaining the desired patterns.

Actuators and electronic circuitry for actuating one probe are known per se, e.g. in the art of SPL or SPM. In a simple embodiment of the invention, each probe can be provided with a respective actuator 14. Electronic circuitry 101, 103 would connect (ref 101) and command (ref 103) the various probes. Also, several circuitries can be contemplated for respective probes; another circuitry would then orchestrate the probe circuitries. Thereby, the force or exposure time of the probes can be independently varied.

Next, varying the temperature would need additional resistive circuitry, as know per se. In this respect, themomechanical cantilevers can advantageously be used to evaporate defined polymer volumes, an evaporated volume defining the lithographic pattern. For example, separation lines smaller than 15 nm can thereby be achieved for linear rectangular patterns created in a polymer with Diels Alder crosslinking. This shall be discussed in somewhat more details later.

As further illustrated in FIG. 4, various shapes can still be contemplated for the distal tips of the probes 10, 20, 30, . . . N×10 (here four different shapes are explicitly shown).

In addition, the probes can have various relative arrangements (linear, parallel, arrays, . . . ). The SPL apparatus can for instance make use of single levers with a system containing multiple levers with different tip shapes. In a variant, it can make use of arrays of cantilever. An array can contain cantilevers with different tip shapes. However, for flexibility and throughput reason, it is preferable to have one or arrays of cantilevers, wherein a same maximal character size is allocated for each cantilever tip, such as to define a constant imprint pitch. Thus, SPL apparatus is easily operated by shifting the arrays from one character at each imprinting step. For instance, FIG. 1 shows an example of two cantilevers fabricated on the same chip but with two different tip shapes.

Whatever arrangement is contemplated, the various probes can be moved above a material surface M30 (as denoted by the double arrows), such that actuating the probes 10, 20, 30 results in a variety of patterns imprinted in the surface thickness M20 of the sample M10.

The tip shapes are preferably dimensioned such as to form nano-scale patterns in the surface thickness M20. In a variant, dimensions can be in the micrometer range or above. The smallest feature of the tip defines the minimum feature size (or minimum pixel), the ratio between the tip character area and the minimum pixel size gives the patterning parallelism achieved by a given tip.

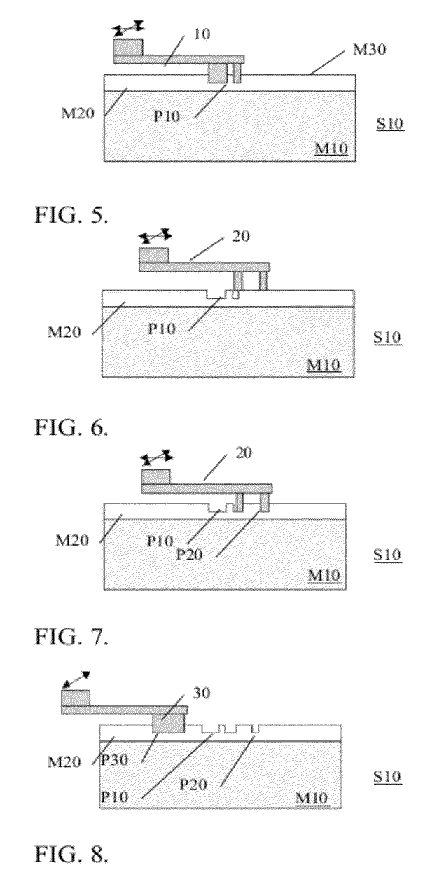

FIGS. 5-12 schematically depict steps of an embodiment of the method according to the invention. Basically, the SPL method contemplated here aims at forming patterns P10, P20, P30, . . . in the surface thickness M20 of a material M10. The surface thickness is typically an imaging resist (polymer). The contiguous material body is e.g. a silicon wafer.

To achieve this, the probes are moved across the surface M30 and actuated to locally interact with the said surface, such as to form respective patterns. As said above, the probe can be independently actuated (concurrent actuation while scanning the surface). A variant consists of imprinting static characters, for instance arranged in arrays, just as in imprint lithography. However, independent actuation of the probes allows for richer diversity of patterns and larger throughput.

Preferably, probes are moved such that a first pattern obtained with a first one of the probes overlaps with a second pattern obtained with a second one of the probes. This is illustrated in FIGS. 5-8.

For example, a first probe 10 locally interacts with the material surface M30 such as to give rise to a first pattern P10 (FIG. 5). A second probe 20 is then moved close to the first pattern P10 (FIG. 6), and then actuated (FIG. 7) such that a second pattern P20 overlaps with the first one P10. As can be seen in FIG. 8, the variety of patterns obtained is increased. Having seen this, one understands that the diversity of obtainable patterns is determined not only by the basis characters terminating the probes, but also by the logic commanding the probes.

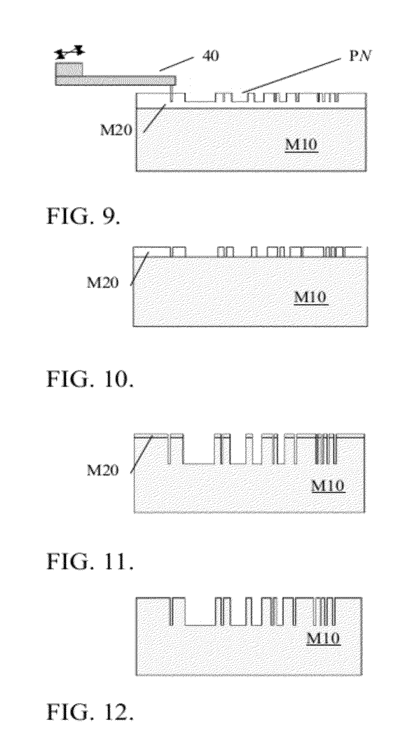

The process is repeated for the subsequent probes, see FIGS. 8 and 9, leading finally to a variety of patterns PN (FIG. 9).

For completeness, the method may further comprise the steps of descumming the surface M30, if necessary (FIG. 10). Then (FIG. 11) the patterns can be transferred in the contiguous layer, using a suitable pattern transfer solution. Finally, the residual resist strip can be removed.

Note that the various probe shapes reflect uniquely in a material obtained (directly or not) thanked to the SPL apparatus of the invention. For instance, a regularity is obtained for a same character imprinted at different locations in the material. In addition, the probe arrangement may lead to typical patterns (beyond a single character) in the patterned surface. A such material can thus easily be characterized and is therefore part of the present invention too.

Last but not least, patterns are advantageously created by desorbing molecules at the surface of the material. To achieve this, one may rely on a material having a polymer film thereon, the film comprising a network of molecules which are cross-linked via intermolecular, noncovalent bonds, such as van der Waals forces, or Hydrogen bonds (e.g. a molecular glass film). Such bonds are not of a covalent bonding nature (at least not essentially, there is no clear electron pairing). Rather, intermolecular bonds provide a better compromise than the usual chemical bonds, inasmuch as the film can remain stable under normal conditions. Typically here, less energy being required at the probes to create the patterns. Nano-scale dimensioned probes are heated such as to desorb molecules when interacting with (e.g. urged against) the film. In other words, molecules evaporate upon interaction with probes. The probes thereby directly engrave patterns into the film, resulting in a clean film. Note that the temperature of the probe, the force exerted by the probe on the imaging polymer and the time of exposure of the probe to the surface can be adjusted according to a characteristic of the cross-linked molecules, in order to achieve desired desorption performances. The average desorption energy of the molecules can be seen as such a characteristic, which is necessarily impacted by the said intermolecular bonds. Since the binding energy caused by the intermolecular links is small (at least compared to covalent links), the process can work at moderate temperatures and short probe-sample interaction times. This, in turns, allows for scaling to fast writing times.

Accordingly, combining the CPL concept herein described with evaporation techniques may turn highly advantageous. In particular, no substantial proximity effect is found when relying on polymer evaporation, which would else impact the quality of the final structure. In addition, unlike with e-beam character projection lithography, ring- or donut-like shape characters can here be obtained.

In a variant to intermolecular crosslinks, one may rely on unzip polymers, that is, a polymer film with chains able to unzip upon suitable stimulation, e.g. upon breaking one chemical bond thereof. Patterning the film can therefore be achieved by stimulating the film for triggering the unzipping reaction of the chains. For instance, energy can be provided to the film via the probe, heated, to activate a chemical reaction involving a reactant, such as a thermal-acid-generator, in proximity with polymer chains, the chemical reaction allowing in turn for triggering an unzipping reaction.

To summarize, a concept of character probe lithography or “CPL” has been described above. An advantage of CPL is to combine the resolution, simplicity and scalability for large arrays of SPL, together with the advantageous throughput of the known character projection technique. As discussed, additional advantages are provided when relying, within the CPL, on polymer evaporation or on unzipping polymers.

The CPL concept does furthermore not only apply to pure lithography applications but also to 3D patterning (e.g. by subsequent imprinting or by a 3D imprint tip shape as illustrated earlier), patterning of chemical contrast for directed assembly, revealing underlying functionality (e.g. recognition sites for directed assembly.

While the present invention has been described with reference to certain embodiments, it will be understood by those skilled in the art that various changes may be made and equivalents may be substituted without departing from the scope of the present invention. In addition, many modifications may be made to adapt a particular situation to the teachings of the present invention without departing from its scope. Therefore, it is intended that the present invention not be limited to the particular embodiment disclosed, but that the present invention will include all embodiments falling within the scope of the appended claims. For example, the present invention may be contemplated for various applications. While embodiments described above shall merely find applications in lithography (and data storage), the skilled person may appreciate potential applications to pattern transfer of patterned regions into silicon, or 3D-topographical patterning.

1. A scanning probe lithography (SPL) apparatus, comprising:
two or more probes with respective shapes,
wherein the respective shapes are different and the respective shapes form, in operation, different patterns in a thickness of a surface of a material processed with the apparatus.

2. The SPL apparatus of claim 1, further comprising means for independently actuating the probes.

3. The SPL apparatus of claim 2, further comprising an electronic circuitry designed to command independent actuation of the probes.

4. The SPL apparatus of claim 2, wherein the probes comprise respective cantilevers, the cantilevers are terminated by respective tips, and the tips have at least two different shapes.

5. The SPL apparatus of claim 1, comprising one or more array of cantilevers, with substantially a same maximal character size allocated to each of the cantilevers.

6. The SPL apparatus of claim 1, the respective shapes have dimensions for forming nano-scale patterns in the surface thickness.

7. The SPL apparatus of claim 1, wherein one or more of the probe shapes is designed for forming a 3D hole pattern in the surface thickness.

8. A scanning probe lithography (SPL) method, comprising the steps of:
providing an SPL apparatus comprising two or more probes with respective shapes, wherein the respective shapes are different and the respective shapes form, in operation, different patterns in a thickness of a surface of a material processed with the apparatus; and
forming the patterns in the thickness of the surface of the material processed with the apparatus.

9. The method of claim 8, wherein the step of forming comprises moving the probes across the surface and independently actuating the probes to make them locally interact with the surface to form respective patterns.

10. The method of claim 9, wherein the step of forming further comprises moving the probes such that a first pattern obtained with a first one of the probes overlaps with a second pattern obtained with a second one of the probes.

11. The method of claim 8, further comprising the steps of:
descumming the surface;
transferring the nano-scale patterns in a layer of material contiguous to the patterned thickness; and
removing residual thickness.

12. The method of claim 8, wherein the step of forming further comprises independently varying an alternative selected from the group consisting of: the forces applied to the probes, the temperatures of the said probes, and exposure times of the probes on the material surface.

13. The method of claim 8, wherein:
the step of providing comprises providing a material having a polymer film with a network of molecules cross-linked via intermolecular, non essentially covalent bonds; and
the step of forming patterns comprises patterning the polymer film with the probes, wherein at least some of the probes are heated to desorb molecules from the network.

14. A material having a surface thickness patterned according a scanning probe lithography (SPL) method, the method comprising:
providing an SPL apparatus comprising two or more probes with respective shapes, wherein the respective shapes are different and the respective shapes form, in operation, different patterns in a thickness of a surface of a material processed with the apparatus; and
forming the patterns in the thickness of the surface of the material processed with the apparatus.

15. The material of claim 14, wherein the patterns are substantially free of proximity effects.

16. The material of claim 14, wherein the step of forming comprises moving the probes across the surface and independently actuating the probes to make them locally interact with the surface to form respective patterns.

17. The material of claim 14, wherein the step of forming further comprises moving the probes such that a first pattern obtained with a first one of the probes overlaps with a second pattern obtained with a second one of the probes.

18. The material of claim 14, wherein the method further comprises the steps of:
descumming the surface;
transferring nano-scale patterns in a layer of material contiguous to the patterned thickness; and
removing residual thickness.

19. The material of claim 14, wherein the step of forming further comprises independently varying an alternative selected from the group consisting of: the forces applied to the probes, the temperatures of the said probes, and exposure times of the probes on the material surface.

20. The material of claim 14, wherein:
the step of providing comprises providing a material having a polymer film with a network of molecules cross-linked via intermolecular, non essentially covalent bonds; and
the step of forming patterns comprises patterning the polymer film with the probes, wherein at least some of the probes are heated to desorb molecules from the network.
